(19) United States
(12) Patent Application Publication
(10) Pub. No.: US 2008/0301988 A1
(43) Pub. Date: Dec. 11, 2008

(54) Flag with replaceable panels

(75) Inventor: Denver Wayne Strader, Springfield, IL (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(73) Assignee: Rivals Flag LLC

(21) Appl. No.: 11/810,728

(22) Filed: Jun. 7, 2007

(51) Int. Cl. G09F 17/00

(52) U.S. Cl. 40/604

(57) ABSTRACT

A flag assembly is provided. The flag assembly includes a flag including a plurality of openings defined therein, and at least one replaceable panel. The replaceable panel includes at least one fastening mechanism. The at least one replaceable panel is coupled to the flag such that the at least one fastening mechanism is at least partially inserted through at least one of the plurality of openings. A method of assembling the flag assembly is also provided.

### CROSS REFERENCE TO RELATED APPLICATIONS

This application claims priority to and the benefit of the filing date of U.S. Design Application Ser. No. 29/240,405 filed on Oct. 13, 2005, the contents of which are hereby incorporated by reference.

### BACKGROUND OF THE INVENTION

This invention relates generally to flags and more specifically, to flags with replaceable panels.

An avid sports fan may have a flag with a team name and/or a team emblem. The sports fan may use the flag to show support of their favorite team, to shown an allegiance to a school they graduated from, to show team spirit on game day, and/or any of a variety of other reasons. However, generally known flags cannot be easily altered and/or customized based on who their team is competing against on game day. For example, a fan of the University of Illinois may want to show their dislike of the University of Michigan in one week, and their dislike of the Ohio State University in a subsequent week, depending on the football schedule. A sports fan could purchase multiple flags in order to customize a flag for game day, but purchasing multiple flags is expensive, as each flag generally provides only limited functionality.

### BRIEF DESCRIPTION OF THE INVENTION

In one aspect, a flag assembly is provided. The flag assembly includes a flag including a plurality of openings defined therein, and at least one replaceable panel. The replaceable panel includes at least one fastening mechanism. The at least one replaceable panel is coupled to the flag such that the at least one fastening mechanism is at least partially inserted through at least one of the plurality of openings.

In a further aspect, a method of assembling a flag assembly is also provided. The method includes providing a flag comprising a plurality of openings defined therein, and coupling at least one replaceable panel comprising at least one fastening mechanism to the flag such that the at least one fastening mechanism is at least partially inserted through at least one of the plurality of openings.

### BRIEF DESCRIPTION OF THE DRAWINGS

FIG. 1 is a front view of an exemplary flag assembly;

FIG. 2 is a rear view of the flag assembly shown in FIG. 1;

FIG. 3 is a front view of a flag that may be used with the flag assembly shown in FIG. 1;

FIG. 4 is a front view of an exemplary replaceable panel that may be used with the flag assembly shown in FIG. 1; and

FIG. 5 is a rear view of the replaceable panel shown in FIG. 4.

### DETAILED DESCRIPTION OF THE INVENTION

The present invention is described below in reference to its application in connection with a flag with replaceable panels.

In one embodiment, the flag includes a marking thereon such as, but not limited to, indicia that communicates a team logo or a team name. For example, the marking may include printed text that indicates a team's name, logos, slogans, and/or trademarks associated with a team, and/or designs, and/or ornamentation that attract attention. The flag and replaceable panels may have any suitable size, shape and/or configuration, i.e. number of sides, whether such sizes, shapes and/or configurations are described and/or illustrated herein.

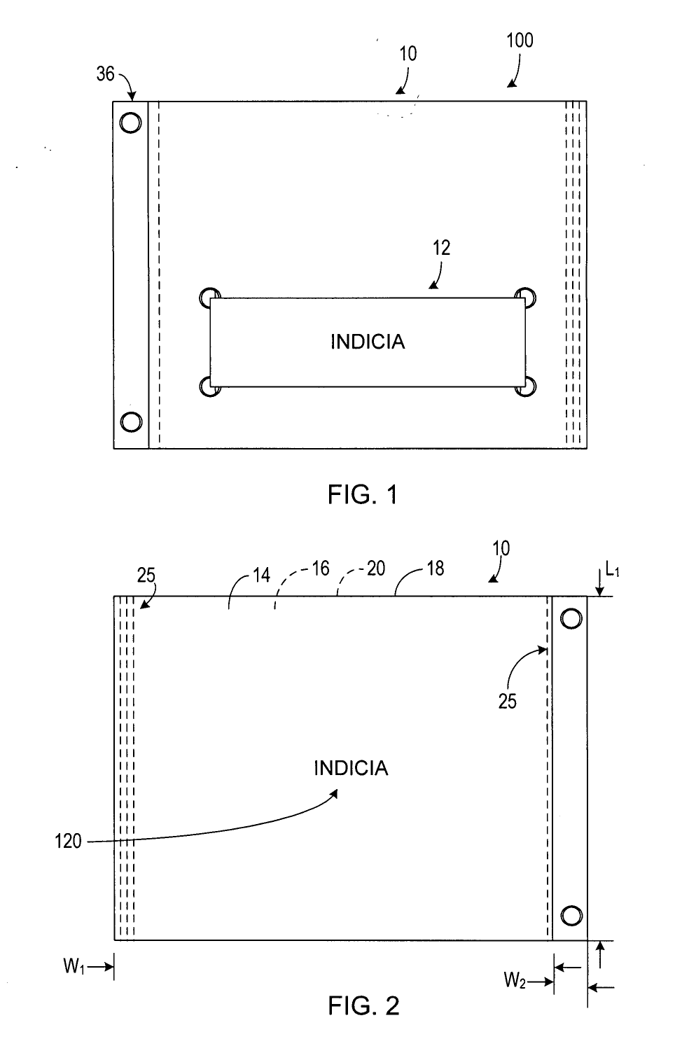

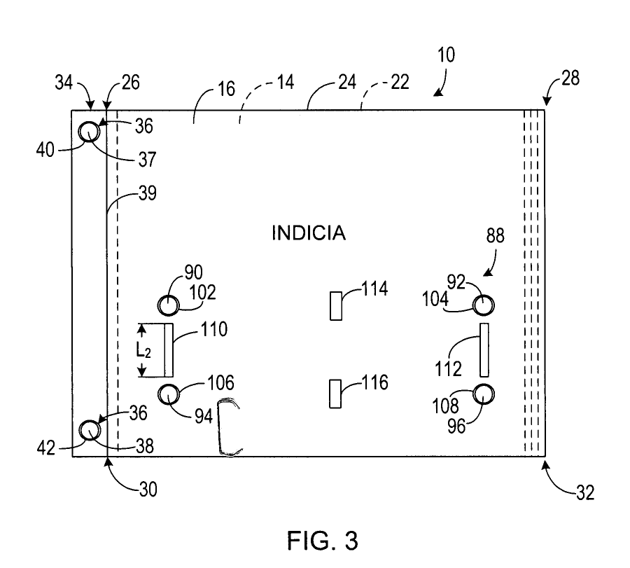

FIG. 1 is a front view of a flag assembly 100, and FIG. 2 is a rear view of flag assembly 100. FIG. 3 is a front view of a flag 10 that may be used with flag assembly 100.

In the exemplary embodiment, flag assembly 100 includes a flag 10 and at least one replaceable panel 12. Specifically, in the exemplary embodiment, flag 10 includes a first flag panel 14 coupled to an opposite second flag panel 16. First flag panel 14 includes a first side 18 and an opposite second side 20, and second flag panel 16 includes a first side 22 and an opposite second side 24. In the exemplary embodiment, first panel second side 20 is coupled against second panel first side 22. For example, in the exemplary embodiment, first flag panel 14 is sewn to second flag panel 16 along a stitch line 25 that extends only two opposing edges of flag 10. In an alternative embodiment, stitch line 25 extends along each edge of flag 10. In a further alternative embodiment, first flag panel 14 may be coupled to second flag panel 16 using any suitable coupling method that enables flag 10 to function as described herein. In an alternative embodiment, first and second flag panel 14 and 16 are formed integrally together.

In the exemplary embodiment, flag 10 is fabricated from a durable material. Specifically, in the exemplary embodiment flag 10 is fabricated from a heavy-duty reinforced nylon that is weather-resistant and fade-resistant. Alternatively, flag 10 may be fabricated from any material that enables flag 10 to function as described herein, such as, but not limited to, a cloth material, a web material, a ribbon material, a leather material, a plastic material, and/or any combination thereof.

Flag 10, in the exemplary embodiment, is substantially rectangular, and is defined by a width W₁, a length L₁, and four corners 26, 28, 30, and 32. In the exemplary embodiment, width W₁ is measured between corners 26 and 28 and equal to approximately five feet. In the exemplary embodiment, length L1 is measured between corners 26 and 30 and equal to approximately three feet. Alternatively, flag 10 may be defined by any width W₁ and length L₁ that enables flag 10 to function as described herein.

Moreover, in the exemplary embodiment, a reinforcing member 34 is coupled to flag 10 along an outer edge 39 of flag 10 extending between corners 26 and 30. Reinforcing member 34 may couple a portion of flag panels 14 and 16 together while enhancing the structural integrity of edge 39. In the exemplary embodiment, reinforcing member 34 is a strip of material that extends along substantially the entire length L₁ of flag 10. In the exemplary embodiment, member 34 has a width W₂ of approximately one inch. Alternatively, reinforcing member 34 has any width W₂ that enables flag assembly 100 to function as described herein. Moreover, in the exemplary embodiment, reinforcing member 34 includes a first set of openings 36 defined therein that enable flag 10 to be coupled to a structure (not shown); such as a flag pole. Specifically, member 34 includes a first opening 37 and a second opening 38 defined therein. Opening 37 is positioned in close proximity to flag corner 26 and opening 38 is positioned in close proximity to flag corner 30. In an alternative embodiment, member 34 may include any number of openings 36 and/or any other known coupling device that enables flag 10 to be coupled to a structure.

Flag 10 also includes a plurality of grommets. In the exemplary embodiment, each grommet extends circumferentially about each opening 38 to reinforce flag 10 around each opening 36 and to facilitate prevent tearing of flag 10. In the exemplary embodiment, a first set of grommets, i.e. grommets 40 and 42, are coupled about openings 37 and 38. In an alternative embodiment, flag 10 includes any number of grommets that enable flag 10 to function as described herein.

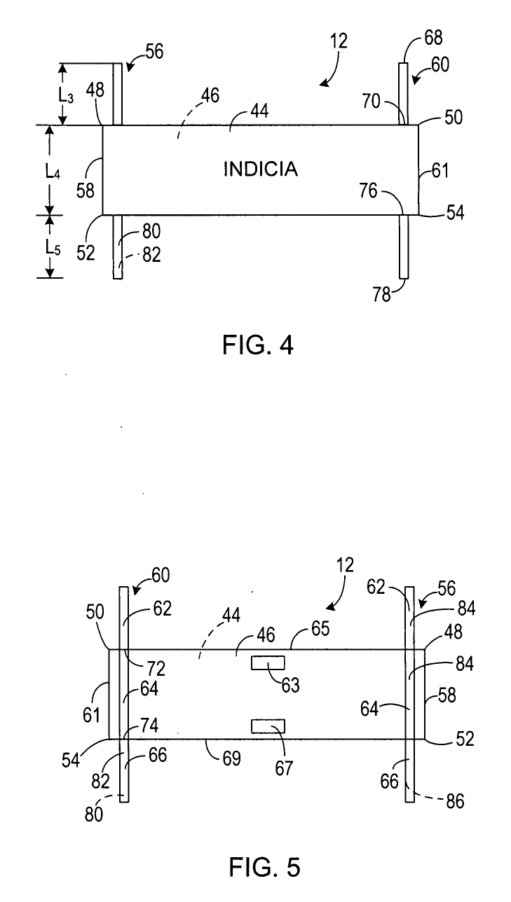

FIG. 4 is a front view of an exemplary replaceable panel 12 that may be used with flag assembly 100, and FIG. 5 is a rear view of replaceable panel 12. Flag assembly 100 includes at least one replaceable panel 12. In the exemplary embodiment, replaceable panel 12 includes indicia and is fabricated from a material that is substantially similar to the material of flag 10. In an alternative embodiment, replaceable panel 12 is fabricated from any suitable material that enables flag 10 to function as described herein. In an alternative embodiment, flag 10 includes a plurality of replaceable panels 12. For example, in one embodiment, first panel first side 18 and second panel second side 25 each include at least one replaceable panel 12.

In the exemplary embodiment, replaceable panel 12 has a first side 44 and an opposing second side 46. Moreover, replaceable panel 12 is substantially rectangular and has a width W₂, a length L₂, and four corners 48, 50, 52, and 54. In the exemplary embodiment, width W₂ is measured between corners 48, 50 and is approximately three feet long. In the exemplary embodiment, length L₂ is measured between corners 48, 52 and corners 50, 54 and is approximately 18 inches long. Alternatively, replaceable panel 12 may be formed with any shape and/or size that enables flag assembly 100 to function as described herein.

Replaceable panel 12 includes at least one fastening mechanism that enables it to couple to flag 10. Specifically, in the exemplary embodiment, replaceable panel 12 includes four fastening mechanisms 56, 60, 63, and 67. More specifically, in the exemplary embodiment, a first fastening mechanism 56 is coupled to replaceable panel 12 adjacent an edge 58 extending between corners 48 and 52, and a second fastening mechanism 60 is coupled to replaceable panel 12 adjacent an edge 61 extending between corners 50 and 54. A third fastening mechanism 63 is coupled to replaceable panel 12 adjacent an edge 65 defined between corners 48 and 50, and a fourth fastening mechanism 67 is coupled to replaceable panel 12 adjacent an edge 69 defined between corners 52 and 54.

In the exemplary embodiment, each fastening mechanism 56, 60, 63, and 67 is coupled to replaceable panel second side 46. In the exemplary embodiment, each fastening mechanism 56, 60, 63, and 67 is fabricated from a hooked loop material. Alternatively, any other suitable fastening device or retaining device may be used which facilitates coupling replaceable panel 12 to flag 10, including, but not limited to mechanical devices, snap fitting devices, interlocking devices, hook and pile fasteners, hook and loop fasteners, tab and slot devices, locking mechanisms, magnets, tying systems, or clips. Alternatively, each fastening mechanism 56, 60, 63, and 67 may be coupled to either first side 44 and/or second side 46.

In the exemplary embodiment, each fastening mechanism 56 and 60 includes a first portion 62, a second portion 64, and a third portion 66. Each first portion 62 has a length L₃ extending between a first end 68 and a second end 70, each second portion 64 has a length L₄ extending between a first end 72 and a second end 74, and each third portion 66 has a length L₅ extending between a first end 76 and a second end 78. In the exemplary embodiment, lengths L₃, L₄, and L₅ are approximately equal. Moreover, in the exemplary embodiment, lengths L₃, L₄, and L₅ are approximately equal to length L₂. Alternatively, lengths L₃, L₄, and L₅ may be any suitable length that enables panel 12 to function as described herein. In the exemplary embodiment, first portion 62 and second portion 64 are formed integrally together. Alternatively, first portion 62 and second portion 64 are formed separately and coupled together.

In the exemplary embodiment, each of the first, second, and third portions 62, 64, and 66, respectively, has a first side 80 and an opposing second side 82. In the exemplary embodiment, the first sides 80 of portions 62 and 64 include a female coupling surface 84 and the second side 82 of portion 66 includes a male coupling surface 86. Surfaces 84 and 86 are configured to “couple” to one another. Moreover, in the exemplary embodiment, first portion 62 is coupled to panel second side 46 such that its end 68 is near corner 48, and such that its second side 82 is in a mirrored relationship with panel second side 46. Similarly, second portion 64 is coupled to second side 46 near edge 58, such that its end 72 is near corner 48 and such that its end 74 is near corner 52. Moreover, second portion second side 82 is in a mirrored relationship with panel second side 46. Third portion 66 is coupled to panel second side 46 such that its end 76 is near corner 52 and such that its second side 82 is in a mirrored relationship with panel second side 46.

With respect to fastening mechanisms 63 and 67, in the exemplary embodiment, each fastening mechanism 63 and 67 is coupled to second panel second side 24. Specifically, in the exemplary embodiment, fastening mechanism 63 is coupled between corners 48 and 50, and fastening mechanism 67 is coupled between corners 52 and 54. Alternatively, each fastening mechanism 56, 60, 63, and 67 may be coupled to flag 10 in any orientation that enables flag assembly 100 to function as described herein.

In the exemplary embodiment, second flag panel 16 also includes a second set of openings 88 defined therein and sized to receive a mechanism therethrough to couple replaceable panel 12 to second flag panel 16, as will be described in more detail below. Specifically, in the exemplary embodiment, flag panel 16 includes openings 90, 92, 94, and 96. Moreover, in the exemplary embodiment, openings 90 and 92 and openings 94 and 96 are separated by a distance W₂, and openings 90 and 94 and openings 92 and 96 are separated by length L₂. Alternatively, flag panel 16 may include any number of openings 88.

In the exemplary embodiment, a second set of grommets 101 including grommets 102, 104, 106, and 108 are coupled around each respective opening 90, 92, 94, and 96 to facilitate reinforcing flag 10 about each opening. Second set of grommets 101 also enables replaceable panel 12 to be easily coupled to flag 10. Alternatively, flag 10 includes any number of grommets that enables flag 10 to function as described herein. In another alternative embodiment, the second set of grommets 101 are coupled to any portion of flag 10 and/or reinforcing member 34 that enables flag 10 to function as described herein.

In the exemplary embodiment, flag 10 also includes a pair of fastening mechanisms 110 and 112 coupled to second panel second side 24. Specifically, in the exemplary embodiment, a first fastening mechanism 110 is coupled between openings 90 and 94, and a second fastening mechanism 112 is coupled between openings 92 and 96. Mechanisms 110 and 112 are configured to couple to mechanisms 56 and 60. In the exemplary embodiment, each fastening mechanism 110 and 112 is fabricated from a hooked loop material. Alternatively, any other suitable fastening device or retaining device may be used which facilitates coupling replaceable panel 12 to flag 10, including, but not limited to mechanical devices, snap fitting devices, interlocking devices, hook and pile fasteners, hook and loop fasteners, tab and slot devices, locking mechanisms, magnets, tying systems, or clips. Alternatively, each fastening mechanism 110 and 112 may be coupled to either first side 24 and/or second side 26.

Moreover, flag 10 includes a pair of fastening mechanisms 114 and 116 coupled to second panel second side 24. Specifically, in the exemplary embodiment, fastening mechanism 114 is coupled between openings 90 and 92, and fastening mechanism 116 is coupled between openings 94 and 96. Mechanisms 114 and 116 are configured to couple to mechanisms 63 and 67. In the exemplary embodiment, each fastening mechanism 114 and 116 is fabricated from a hooked loop material. Alternatively, any other suitable fastening device or retaining device may be used which facilitates coupling replaceable panel 12 to flag 10, including, but not limited to mechanical devices, snap fitting devices, interlocking devices, hook and pile fasteners, hook and loop fasteners, tab and slot devices, locking mechanisms, magnets, tying systems, or clips. Moreover, alternatively, each fastening mechanism 114 and 116 may be coupled to either first side 24 and/or second side 26. Alternatively, each fastening mechanism 110, 112, 114, and 116 may be coupled to flag 10 in any orientation that enables flag assembly 100 to function as described herein.

In the exemplary embodiment, flag 10 is marked with indicia 120. Specifically, in the exemplary embodiment, each first panel first side 18, second panel second side 24, and replaceable panel first side 44 includes indicia 120. Alternatively, any portion and/or panel of flag assembly 100 may include indicia 120. In the exemplary embodiment, indicia 120 is affixed to flag 10 via a print screening process. Alternatively, indicia 120 may be affixed to flag 10 using any known suitable method such as, but not limited to sewing, adhesively coupling, and/or any combination thereof. Alternatively, indicia 120 may be removably coupled to flag 10.

In the exemplary embodiment, during use, replaceable panel 12 is removably coupled to flag 10. Specifically, replaceable panel second side 46 is positioned against second panel second side 24, and fastening mechanisms 63 and 114, and fastening mechanisms 67 and 116, are coupled to facilitate securing panel 12 to flag 10. The first portion 62 of fastening mechanism 56 is inserted through opening 90, the third portion 66 of fastening mechanism 56 is inserted through opening 94, and the second portion 64 of fastening mechanism 56 is coupled to fastening mechanism 110, such that surfaces 84 and 86 engage each other. After portions 62 and 66 are inserted through openings 90 and 94, first portion 62 is coupled to third portion 66 such that surfaces 84 and 86 are coupled together to facilitate securing panel 12 to flag 10.

Similarly, the first portion 62 of fastening mechanism 60 is inserted through opening 92, the third portion 66 of fastening mechanism 60 is inserted through opening 96, and the second portion 64 of fastening mechanism 60 is coupled to fastening mechanism 112, such that surfaces 84 and 86 engage each other. After portions 62 and 66 are inserted through openings 90 and 94, first portion 62 is coupled to third portion 66 such that surfaces 84 and 86 are coupled together to facilitate securing panel 12 to flag 10.

Moreover, during use, a user may removably couple replaceable panel 12 to flag 10 using any or all of fastening mechanisms 56, 60, 63, 67, 110, 112, 114, and/or 116. For example, a user may couple mechanism 56 to mechanism 110, mechanism 60 to mechanism 112, mechanism 63 to mechanism 114, and mechanism 67 to mechanism 116. Similarly, a user may remove a replaceable panel 12 from flag 10 by unfastening mechanisms 56, 60, 63, 67, 110, 112, 114, and 116 from one another.

Described herein is a flag assembly including a replaceable panel wherein a user can replace the replaceable panel on a flag. The above-described flag assembly allows an avid sports fan with a flag having a team name and/or a team emblem to easily alter and/or customize the flag based on who their team is competing against on game day. For example, a fan of the University of Illinois may want to display their dislike of the University of Michigan in one week by coupling a replaceable panel with the indicia for the University of Michigan to their flag. The fan may want to display their dislike of the Ohio State University in a subsequent week. Therefore, the fan may remove the replaceable panel with the indicia for the University of Michigan, and the fan may couple a replaceable panel with the indicia representative of the Ohio State University to the flag. A flag having replaceable panels allows a sports fan to purchase a single flag and allows the fan to customize the flag for game day. A flag with replaceable panels allows a user to use a single flag that is customizable to display a plurality of different indicia rather than using multiple flags to display the same different indicia. The replaceable panel is a relatively low cost modification to a flag that significantly increases the utility of the flag.

An exemplary embodiment of a flag assembly is described above in detail. The flag assembly illustrated is not limited to the specific embodiments described herein, but rather, components of each assembly may be utilized independently and separately from other components described herein.

While the invention has been described in terms of various specific embodiments, those skilled in the art will recognize that the invention can be practiced with modification within the spirit and scope of the claims.

What is claimed is:

1. A flag assembly comprising:
a flag comprising a plurality of openings defined therein; and
at least one replaceable panel comprising at least one fastening mechanism, said at least one replaceable panel is coupled to said flag such that said at least one fastening mechanism is at least partially inserted through at least one of said plurality of openings.

2. A flag assembly in accordance with claim 1 wherein said flag further comprises at least one reinforcing mechanism coupled to each of said plurality of openings, said at least one reinforcing mechanism circumscribes each of said plurality of openings to facilitate reinforcing said flag.

3. A flag assembly in accordance with claim 1 wherein said at least one panel fastening mechanism is fabricated from a hooked loop material.

4. A flag assembly in accordance with claim 1 wherein said at least one panel fastening mechanism is at least one of a mechanical device, an interlocking device, a hook and pile fastener, a hook and loop fastener, a tab and slot device, a locking mechanism, a magnet, a tying system, and a clip.

5. A flag assembly in accordance with claim 1 wherein said flag comprises at least one fastening mechanism coupled thereto and is configured to couple to said at least one panel fastening mechanism.

6. A flag assembly in accordance with claim 5 wherein said at least one flag fastening mechanism is fabricated from a hooked loop material.

7. A flag assembly in accordance with claim 5 wherein said at least one flag fastening mechanism is at least one of a mechanical device, an interlocking device, a hook and pile fastener, a hook and loop fastener, a tab and slot device, a locking mechanism, a magnet, a tying system, and a clip.

8. A flag assembly in accordance with claim 1 wherein at least one of said flag and said replaceable panel includes indicia.

9. A flag assembly in accordance with claim 1 wherein said flag further comprises at least one reinforcing member coupled to a portion of said flag to facilitate enhancing the structural integrity of at least one edge of said flag.

10. A flag assembly in accordance with claim 1 wherein said flag comprises a first panel and a second panel wherein said first and second panels are coupled together.

11. A method of assembling a flag assembly, said method comprising:
providing a flag comprising a plurality of openings defined therein; and
coupling at least one replaceable panel comprising at least one fastening mechanism to the flag such that the at least one fastening mechanism is at least partially inserted through at least one of the plurality of openings.

12. A method in accordance with claim 11 further comprising coupling at least one reinforcing mechanism to each of the plurality of openings, the at least one reinforcing mechanism circumscribes each of the plurality of openings to facilitate reinforcing the flag.

13. A method in accordance with claim 11 further comprising coupling at least one fastening mechanism to the flag and coupling the at least one flag fastening mechanism to the at least one panel fastening mechanism.

14. A method in accordance with claim 11 further comprising fabricating the at least one flag fastening mechanism from a hooked loop material, and fabricating the at least one panel fastening mechanism from a hooked loop material.

15. A method in accordance with claim 11 further comprising coupling indicia to at least one of the flag and the replaceable panel.

16. A method in accordance with claim 11 further comprising coupling at least one reinforcing member to a portion of the flag to enhance the structural integrity of at least one edge of the flag.

17. A method in accordance with claim 17 wherein further comprising forming at least one opening within the at least one reinforcing member.

18. A method in accordance with claim 17 further comprising coupling at least one reinforcing mechanism to the at least one opening, the at least one reinforcing mechanism extends circumferentially about the at least one opening to reinforce the flag and the opening.
